(19) United States
(12) Patent Application Publication
(10) Pub. No.: US 2010/0277634 A1
(43) Pub. Date: Nov. 4, 2010

(54) IMAGING APPARATUS AND METHOD OF DRIVING THE SAME

(75) Inventor: Mikio WATANABE, Miyagi (JP)

Correspondence Address: KIMBLE INTELLECTUAL PROPERTY LAW, PLLC, 1701 PENNSYLVANIA AVE., NW, SUITE 300, WASHINGTON, DC, 20006, US

(73) Assignee: FUJIFILM CORPORATION, Tokyo (JP)

(21) Appl. No.: 12/770,216

(22) Filed: Apr. 29, 2010

(30) Foreign Application Priority Data
Apr. 30, 2009 (JP) 2009-110875

(51) Int. Cl. H04N 5/335; H04N 5/235

(52) U.S. Cl. 348/311; 348/362; 348/E05.034; 348/E05.091

(57) ABSTRACT

An imaging apparatus includes: an imaging element in which first and second pixels for storing signal charges in accordance with an amount of received light are alternately arranged in an array; a flash light emission unit that emits flash light in a shooting scene in which the flash light is emitted; and an imaging control unit that exposes the first pixels for a long time, and exposes the second pixels for a short time. The imaging control unit starts the short-time exposure and the long-time exposure at the same time in the shooting scene in which flash light is emitted, ends the short-time exposure earlier than the long-time exposure, and causes the flash light emission unit to start emitting the flash light at required timing immediately before the end timing of the short-time exposure.

### CROSS-REFERENCE TO RELATED APPLICATIONS

This application is based on and claims priority under 35 USC 119 from Japanese Patent Application No. 2009-110875 filed on Apr. 30, 2009; the entire of which are incorporated herein by reference.

### BACKGROUND

1. Technical Field

The present invention relates to an imaging apparatus, which images a subject image with a wide dynamic range, and a method of driving the same, and more particularly, to an imaging apparatus, which performs wide dynamic range shooting at the time of flash light emission, and a method of driving the same.

2. Related Art

There is a method of imaging a wide dynamic range image of a subject by combining long-time exposure and short-time exposure. For example, when a solid-state imaging element is two-field driven to image one subject image, the long-time exposure is first performed in the first shooting field and obtained subject image data is read from the solid-state imaging element, and the short-time exposure is then performed in the second shooting field and obtained subject image data is read from the solid-state imaging element. Then, both sets of the subject image data may be combined to create an image with a wide dynamic range.

When a subject image is imaged by such a method, a flash light emission is performed in case where a shooting scene is dark or shooting into light. However, when a flash light emission amount during the long-time exposure and a flash light emission amount during the short-time exposure are not controlled at an exposure time ratio of the long-time exposure to the short-time exposure, the combined subject image may become an unnatural image. Therefore, in a technology according to the related art which is described in Patent Document 1 (JP-B-3824349 corresponding to US-B-6278490), a method is disclosed in which a flash light emission amount in each shooting field is controlled to avoid degradation of image quality.

In the above-described technology according to the related art, however, long-time exposure and short-time exposure are performed in separate shooting fields. Therefore, the simultaneity between the subject image obtained by the long-time exposure and the subject image obtained by the short-time exposure is not guaranteed, and a slight time difference occurs.

Therefore, another method is disclosed in which a number of pixels formed in the solid-state imaging element are divided into a first pixel group and a second pixel group, and while the first pixel group is exposed for a long time, the second pixel group is exposed for a short time to guarantee the simultaneity. When such a driving method is used, a bright image is shot without any problems. However, when a flash light emission is performed in case where a shooting scene is dark or shooting into light, the flash light emission amount is not precisely controlled to the exposure time ratio such that the subject image may result in a feeling of strangeness.

Such a problem may be solved by an apparatus disclosed in Patent Document 2 (JP-B-4014620) below. The apparatus performs a flash light emission through a plurality of short-pulse light emissions to finely control the respective flash light emission amounts in long-time exposure and short-time exposure. However, the apparatus which performs a flash light emission using short-pulse light emissions has a different problem in that its

### SUMMARY

An illustrative aspect of the present invention is to provide an imaging apparatus which drives a solid-state imaging element using a method for guaranteeing the simultaneity between a subject image obtained by long-time exposure and a subject image obtained by short-time exposure and controls a flash light emission amount to an exposure time ratio of long-time exposure and short-time exposure to obtain wide-dynamic-range subject image data without strangeness, even when a subject is illuminated by one pulse of flash light emission, and a method of driving the same.

[1] According to an aspect of the invention, an imaging apparatus includes an imaging element, a flash light emission unit and an imaging control unit. The imaging element in which first and second pixels for storing signal charges in accordance with an amount of received light are alternately arranged in an array. The flash light emission unit emits flash light in a shooting scene in which the flash light is emitted. The imaging control unit exposes the first pixels for a long time, and exposes the second pixels for a short time. An exposure period of the short-time exposure corresponds to a portion of an exposure period of the long-time exposure. The imaging control unit starts the short-time exposure and the long-time exposure at the same time in the shooting scene in which flash light is emitted, ends the short-time exposure earlier than the long-time exposure, and causes the flash light emission unit to start emitting the flash light at required timing immediately before the end timing of the short-time exposure.

[2] According to another aspect of the invention, a method of driving an imaging apparatus which images a subject image by emitting flash light in a shooting scene in which flash light is emitted and using an imaging element in which first and second pixels for storing signal charges in accordance with an amount of received light are alternately arranged in an array, the method includes: exposing the first pixels for a long time; exposing the second pixels for a short time, a exposure period of the short-time exposure corresponding to a portion of a exposure period of the long-time exposure; starting the short-time exposure and the long-time exposure at the same time in the shooting scene in which the flash light is emitted; ending the short-time exposure earlier than the long-time exposure, and starting the flash light emission at required timing immediately before the end timing of the short-time exposure.

With the configuration of [1] and [2], it is possible to perform a flash light emission in which a light amount ratio is controlled when shooting a short-time exposed image and a long-time exposed image where the simultaneity is guaranteed. Even in a shooting scene where the flash light emission is required, a subject image with a wide dynamic range can be imaged.

### BRIEF DESCRIPTION OF THE DRAWINGS

FIG. 1 is a function block diagram of an imaging apparatus according to an embodiment of the present invention.

FIG. 2 is a diagram schematically showing the surface of an imaging element shown in FIG. 1.

FIG. 3 is a schematic cross-sectional view taken along a line of FIG. 2.

FIG. 4 is a diagram simply showing respective color pixel arrangements of the solid-state imaging element shown in FIG. 2.

FIG. 5 is a flow chart showing the processing procedure of a method of driving the imaging apparatus according to the embodiment of the present invention.

FIG. 6 is a driving timing chart when a flash light emission is not performed in the imaging apparatus according to the embodiment of the present invention.

FIG. 7 is a driving timing chart when a flash light emission is performed in the imaging apparatus according to the embodiment of the present invention.

FIG. 8 is a diagram for explaining that signal charges are read from short-time exposure pixels in the imaging apparatus according to the embodiment of the present invention.

FIG. 9 is a diagram for explaining that signal charges are read from long-time exposure pixels in a first field in the imaging apparatus according to the embodiment of the present invention.

FIG. 10 is a diagram for explaining that signal charges are read from long-time exposure pixels in a second field in the imaging apparatus according to the embodiment of the present invention.

FIG. 11 is a diagram for explaining that signal charges are read from the long-time exposure pixels in a high-sensitivity shooting mode in the imaging apparatus according to the embodiment of the present invention.

FIG. 12 is a diagram for explaining that noise charges are read in the imaging apparatus according to the embodiment of the present invention.

### DETAILED DESCRIPTION

Hereinafter, an exemplary embodiment of the present invention will be described with reference to the drawings.

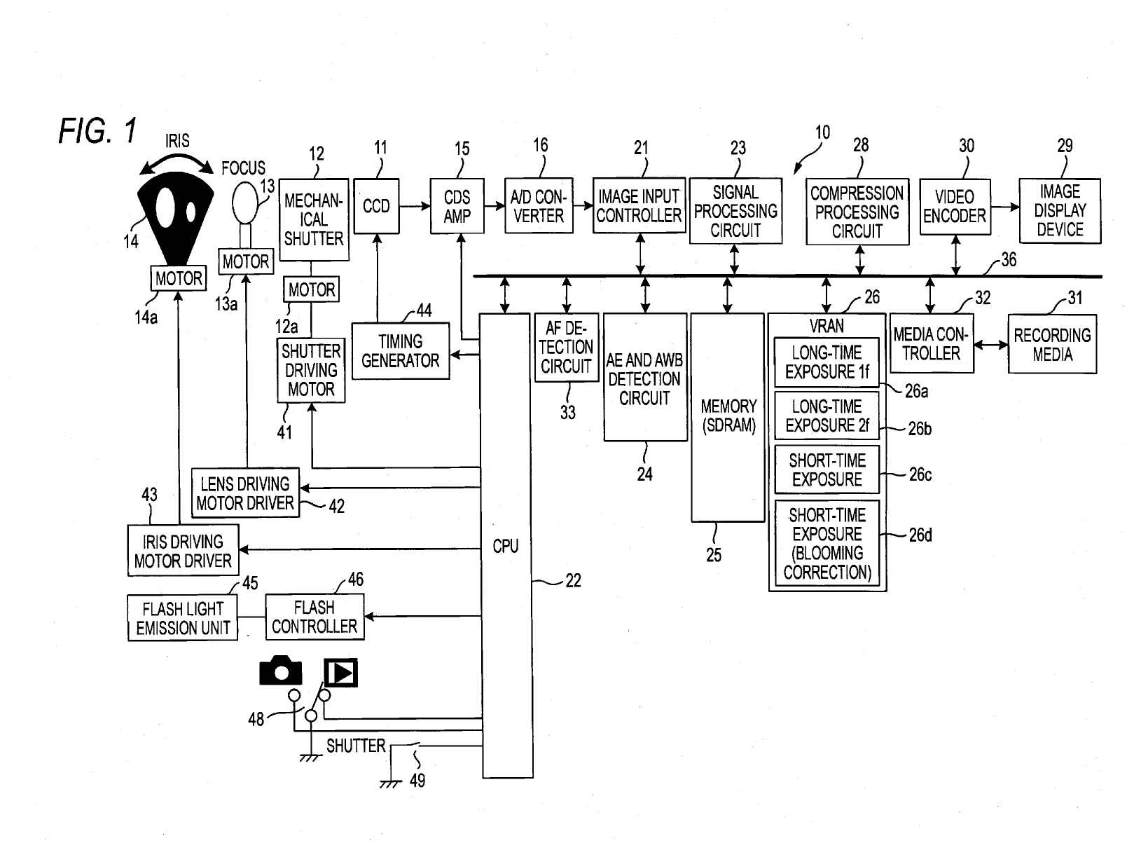

FIG. 1 is a function block diagram of an imaging apparatus according to an embodiment of the present invention. The imaging apparatus (digital still camera in this embodiment) 10 includes a charge-coupled device (CCD) solid-state imaging element 11, a mechanical shutter 12 positioned in the front stage of the solid-state imaging element 11, a shooting lens 13, an iris 14, a correlation double sampling gain control amplifier (CDS AMP) 15 which processes output signals (picked-up image signal) of the solid-state imaging element 11 in an analog manner, and an analog-digital (A/D) converter 16 which converts output signals of the CDSAMP 15 into digital signals.

The imaging apparatus 10 further includes an image input controller 21, a CPU 22, a digital signal processing circuit 23, an AE & AWB detection circuit 24, an SDRAM 25, a frame memory (VRAM) 26, a compression processing circuit 28, a video encoder 30, a media controller 32, an autofocus (AF) detection circuit 33, and a bus 36. The image input controller 21 receives picked-up image signals which are digital signals output from the A/D converter 16. The CPU 22 performs an overall control of the imaging apparatus 10. The digital signal processing circuit 23 performs well-known image processing on the picked-up image signal. The image processing may include offset processing, y correction processing, RGB/YC conversion processing, synchronization processing and so on. The AE & AWB detection circuit 24 automatically detects an exposure amount and white balance from picked-up image data output from the solid-state imaging element 11. The SDRAM 25 is used as work memory. The compression processing circuit 28 compresses the image-processed image data into a JPEG image or MPEG image. The video encoder displays a shot image or through image on a liquid crystal display device 29 provided on the rear surface of the camera. The media controller 32 stores picked-up image data in a recording media 31. The AF detection circuit 33 detects a focus position from the picked-up image data output from the solid-state imaging element 11. The bus 36 connects the respective elements to one another.

The imaging apparatus 10 further includes motor drivers 41 to 43, a timing generator 44, and a flash controller 46. The motor driver 41 supplies a driving pulse to a driving motor 12a of the mechanical shutter 12. The motor driver 42 supplies a driving pulse to a motor 13a which drives the focus lens positioning of the shooting lens 13. The motor driver 43 supplies a driving pulse to a driving motor 14a which performs an iris position control of the iris 14. The timing generator 44 supplies a driving timing pulse (for example, an electronic shutter pulse, a read pulse, a transfer pulse, a line memory control pulse and so on) to the solid-state imaging element 11. The flash controller 46 applies a light emission instruction pulse to a flash light emission unit 45. These elements operate on the basis of commands from the CPU 22. Furthermore, the CDSAMP 15 also operates on the basis of commands from the CPU 22.

The CPU 22 is connected to a switch 48 which switches between a shooting mode and a reproduction mode and a shutter release button 49 of a two-stage shutter, and controls the imaging apparatus 10 on the basis of user instructions input from the switch 48 and the shutter release button 49.

The VRAM 26 includes a data storage region 26a, a data storage region 26b, a data storage region 26c, and a noise correction data storage region 26d. The data storage region 26a stores data which are imaged through long-time exposure, read in a second field, and read in a first field through long-time exposure. The data storage region 26b stores data which are imaged through the long-time exposure and read in a second field. The data storage region 26c stores data which are read through short-time exposure. The noise correction data storage region 26d stores noise correction data such as blooming.

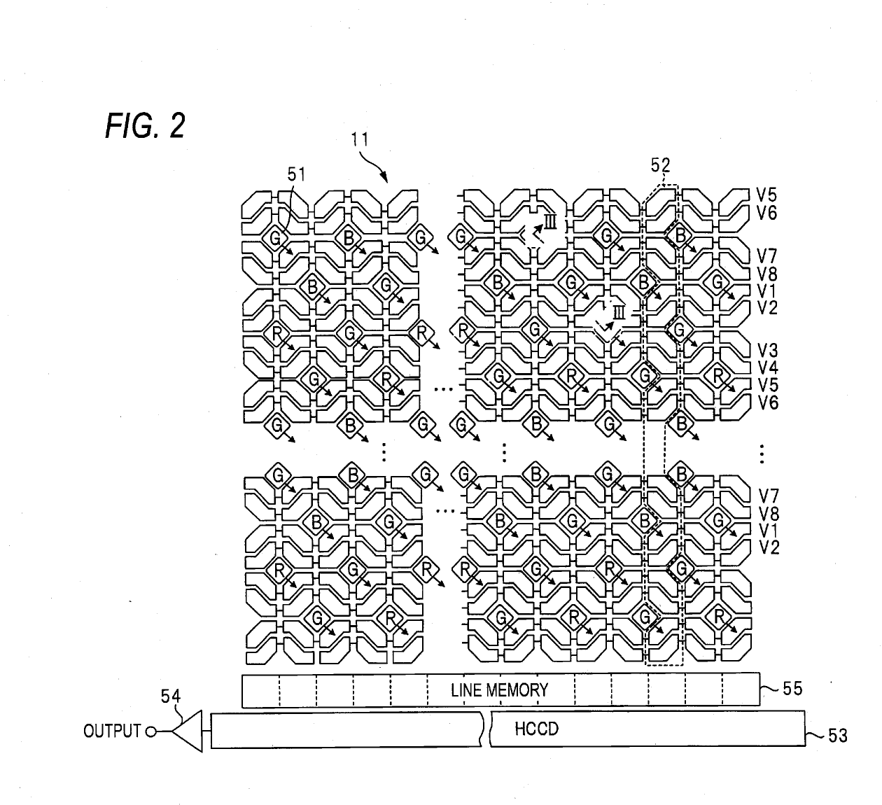

FIG. 2 is a diagram schematically showing the surface of the CCD solid-state imaging element 11 shown in FIG. 1. The solid-state imaging element 11 includes a plurality of photodiodes 51 which are arranged in a two-dimensional array on a surface of a semiconductor substrate. The photodiodes 51 are indicated by diagonal squares in the drawing.

When a group of photodiodes positioned in odd-number lines is set to a first pixel group and a group of photodiodes positioned in even-number lines is set to a second pixel group, the first pixel group and the second pixel group are formed so as to be spaced from each other by ½ pixel pitch. As a whole, the first and second pixel groups form a so-called honeycomb pixel arrangement.

When looking at only the first pixel group, the respective pixels 51 are arranged in a square lattice shape. On the respective pixels, the color filters in three primary colors (red, green, and blue) are arranged so as to form a Bayer arrangement. Even when looking at only the second pixel group, the respective pixels 51 are arranged in a square lattice shape. On the respective pixels, the color filters in three primary colors (red, green, and blue) are arranged so as to form a Bayer arrangement.

A vertical charge transfer path (VCCD) 52 is formed to snake along each pixel line. A horizontal charge transfer path (HCCD) 53 is formed along a transfer-direction end of each vertical charge transfer path 52. The horizontal charge transfer path 53 includes an amplifier 54 provided at an output end thereof, the amplifier 54 outputting a voltage level signal as a picked-up image signal depending on the amount of transferred signal charges. Furthermore, a line memory 55 having a buffer area for each vertical charge transfer path 52 is provided between the transfer-direction end of the vertical charge transfer path 52 and the horizontal charge transfer path 53.

The line memory 55 is a line memory such as that disclosed in JP-A-2002-112119 and JP-A-2002-112122 (corresponding to US-A-2002/0039144). The line memory 55 has a function of temporarily storing signal charges received from the vertical charge transfer path 52 in accordance with a line memory control pulse and transferring the stored signal charges to the horizontal charge transfer path 53 at transmission timing of the horizontal charge transfer path 53. Accordingly, for example, signal charge of a certain R pixel and signal charge of an R pixel disposed at the left-diagonal downward position of the certain R pixel can be added on the horizontal charge transfer path.

Each of the pixels 51 includes two transfer electrodes. One of the two transfer electrodes, for example, a lower transfer electrode positioned in the side of the horizontal charge transfer path (HCCD) 53, serves also as a read electrode. A read pulse for the first pixel group is commonly applied to the read electrodes of the first pixel group, and a read pulse for the second pixel group is applied to the read electrodes of the second pixel group. In FIG. 2, arrows directed to the right-diagonal downward direction from each of the pixels indicate the read direction and read positions of signal charges.

Hereinafter, the descriptions will be made such that the first pixel group consists of pixels for long-time exposure and the second pixel group consists of pixels for short-time exposure. Furthermore, although terms such as ‘vertical’ and ‘horizontal’ are used, these terms simply indicate ‘one direction’ along the surface of the semiconductor substrate and ‘a direction perpendicular to the one direction’.

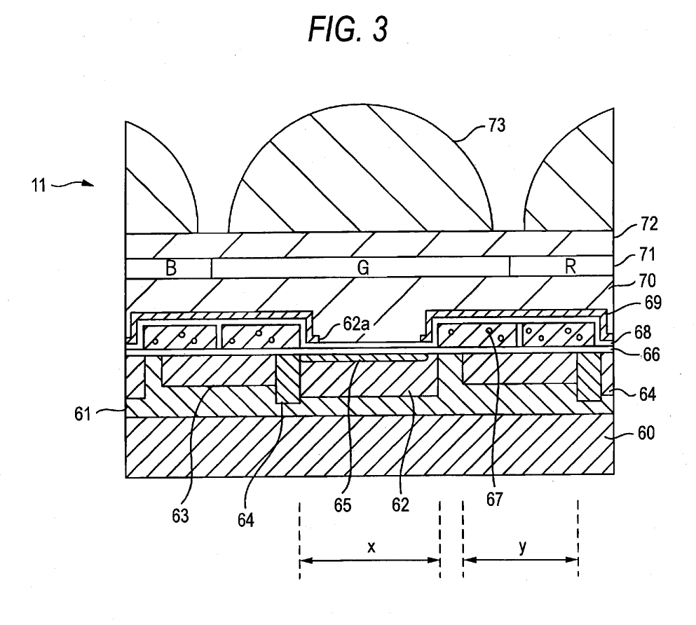

FIG. 3 is a schematic cross-sectional view taken along a line of FIG. 2. Referring to FIG. 3, a p-well layer 61 is formed on the surface of an n-type semiconductor substrate 60. The p-well layer 61 includes an n region 62 and an n-type buried channel 63 which are alternately formed. The n region 62 is a region for storing signal charges, and the n-type buried channel 63 composes the vertical charge transfer path 52.

The n region 61 and the buried channel 63 through which the signal charges of the n region 61 are read and transferred form one set. Between the adjacent sets, an element separation region 64 is provided as a high-concentration p-type region. On the surface of the n region 61, a high-concentration p layer 65 for controlling dark current is provided. On the uppermost surface of the semiconductor substrate 60, a gate insulating layer 66 is provided.

A transfer electrode layer 67 of the vertical charge transfer path 52 is formed on the buried channel 63 via the gate insulating layer 66. The transfer electrode layer 67 is formed of a polysilicon layer. On the transfer electrode layer 67, an insulating layer 68 is formed. On the insulating layer 68, a light shielding layer 69 made of tungsten or the like is formed. The light shielding layer 69 includes an opening portion 69a provided above the n region 61.

On the light shielding layer 69, a transparent planarization layer 70 is stacked. On the planarization layer 70, a color filter layer (R, G, and B) 71 is stacked. On the color filter layer 71, a planarization layer 72 is stacked. On the planarization layer 72, a microlens (top lens) layer 73 is stacked.

In the CCD solid-state imaging element 11, incident light from a subject is focused by the microlens 73. Then, the focused light is incident on the n region 62 through the light shielding layer opening portion 69a, and signal charges depending on the exposure amount are stored in the n region 62. The signal charges obtained through the color filter G become a charge amount depending on the amount of green incident light, the signal charges obtained through the color filter R become a charge amount depending on the amount of red incident light, and the signal charges obtained through the color filter B become a charge amount depending on the amount of blue incident light.

The signal charges stored in the n region 62 moves to the buried channel 63 of the adjacent vertical charge transfer path 52, when a read pulse is applied to the read electrode 67 serving as a transfer electrode. Then, the signal charges are transferred toward the line memory 55 along the vertical charge transfer path 52, and transferred from the line memory 55 to the horizontal charge transfer path 53. Furthermore, the signal charges are transferred along the horizontal charge transfer path 53, and a voltage level signal depending on the signal charge amount 5 is output as a picked-up image signal from the amplifier 54.

Two pixels having the same color, which are pixel-added in the horizontal direction by the line memory 55, may be set to a long-time exposure pixel and a short-time exposure pixel. In this case, the addition of signal charge amounts in the solid-state imaging element can be performed. However, of course, a picked-up image signal of the long-time exposure pixel and a picked-up image signal of the short-time exposure pixel may be separately read from the solid-state imaging element 11 and stored in the frame memory 26 of FIG. 1 such that data addition is performed in the frame memory 26. Any one of the methods may be used to obtain picked-up image data with a wide dynamic range. Furthermore, the method of performing the pixel addition in the solid-state imaging element and the method of performing the pixel addition outside the solid-state imaging element may be alternately used depending on shooting scenes.

In recent years, the area of the light reception portion (the n region 62) of a CCD solid-state imaging element 11 has increased to realize high sensitivity. That is, the width x of the n region 62 shown in FIG. 3 has increased. Therefore, the width y of the buried channel 63 has inevitably become narrower, so that the stored charges (signal charges) of the n region 62 with a large area may not be read from the solid-state imaging element 11 by one read transfer operation. Accordingly, a multi-field read operation is generally performed in the recent CCD solid-state imaging element.

For example, when a two-field read operation is performed, the signal charges of alternate pixels among the vertical direction pixels in the first pixel group described by referring to FIG. 2 is read and transferred in the first field and then output from the solid-state imaging element 11. Furthermore, the signal charges of the remaining pixels of the first pixel group are read and transferred in the second field and then output from the solid-state imaging element 11. In this embodiment, the signal charges obtained by the long-time exposure are two-field read as will be described below.

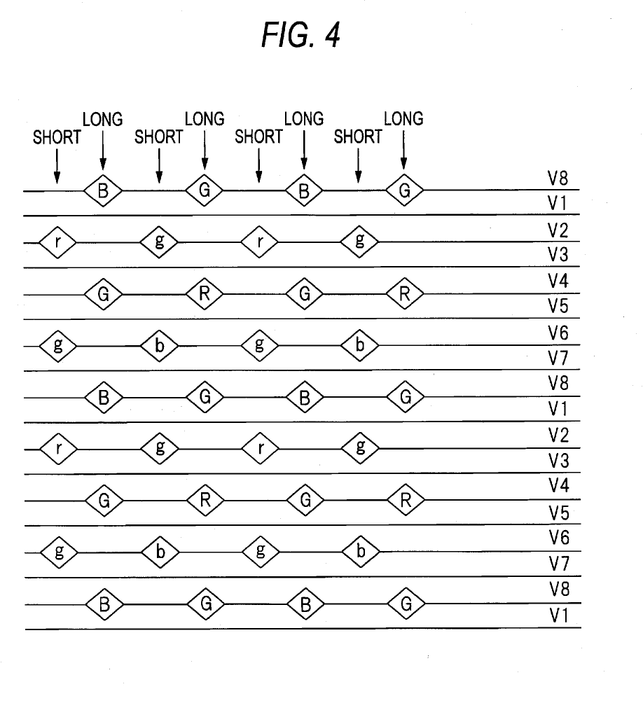

FIG. 4 is a diagram simply showing respective color pixel arrangements of the solid-state imaging element shown in FIG. 2. One pixel line between an odd-number pixel line and an even-number pixel line is set to the first pixel group, and the other pixel line is set to the second pixel group. Furthermore, the first pixel group is exposed for a long time, and the second pixel group is exposed for a short time. However, even though the pixel groups are seen as ‘pixel rows’, long-time exposure pixel rows and short-time exposure pixel rows are alternately arranged.

In FIG. 4, color pixels of the pixels exposed for a long time are represented by uppercase letters R, G, and B, and color pixels of the pixels exposed for a short time are represented by lowercase letters r, g, and b. The signal charges of the same color pixels adjacent in a diagonal direction may be added to obtain subject image data R+r, G+g, and B+b with a wide dynamic range. In this case, the signal charges may be added in the solid-state imaging element using the line memory 55 or may be read from the solid-state imaging element and then added, as described above.

When the signal charges of the long-time exposure pixels (the first pixel group) are read into the vertical charge transfer path 52, a read pulse may be applied to read electrodes V1 and V5 shown in FIG. 4. When the signal charges of the short-time exposure pixels (the second pixel group) are read into the vertical charge transfer path 52, a read pulse may be applied to read electrodes V3 and V7 shown in FIG. 4.

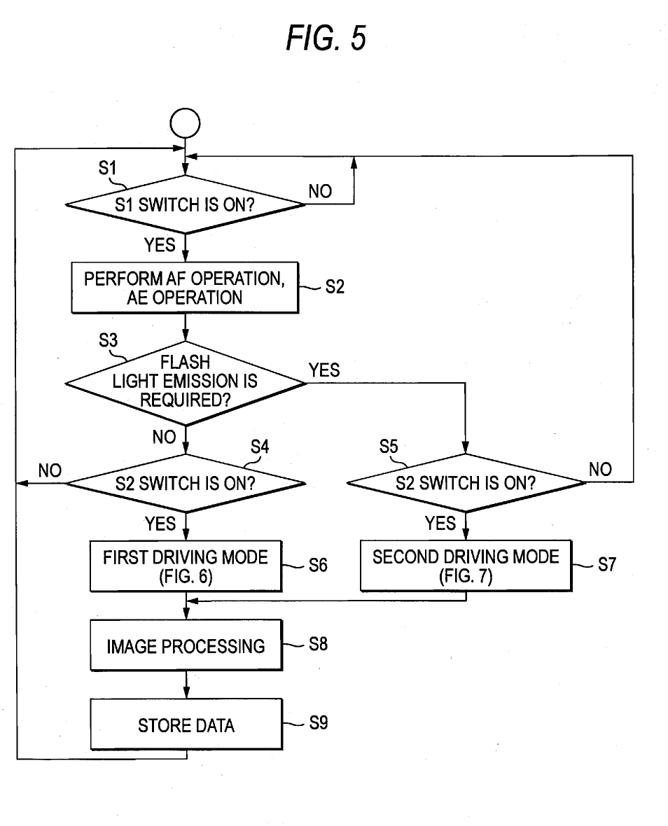

FIG. 5 is a flow chart showing the processing procedure of a method of driving the imaging element, which is performed in the imaging apparatus 10 according to the embodiment of the present invention. When power is supplied to the imaging apparatus 10 shown in FIG. 1 and the switch 48 is set to the imaging mode, a control program is activated and first waits for an S1 switch of the two-stage shutter button to be turned on (step S1). When the S1 switch is turned on, the imaging apparatus 10 performs an AF operation and an AE operation to calculate a focus position to a subject and perform photometry (step S2).

In step S3, it is determined whether a flash light emission is required or not, based on the photometry result. When the flash light emission is not required, the process proceeds to step S4 to determine whether or not an S2 switch of the two-stage shutter button is turned on. When the S2 switch is not turned on, the process returns to step S1 and steps S1 to S4 are repetitively performed.

When it is determined in step S3 that the flash light emission is required, the process proceeds to step S5 to determine whether or not the S2 switch of the two-stage shutter button is turned on. When the S2 switch is not turned on, the process returns to step S1 and steps S1, S2, S3, and S5 are repetitively performed.

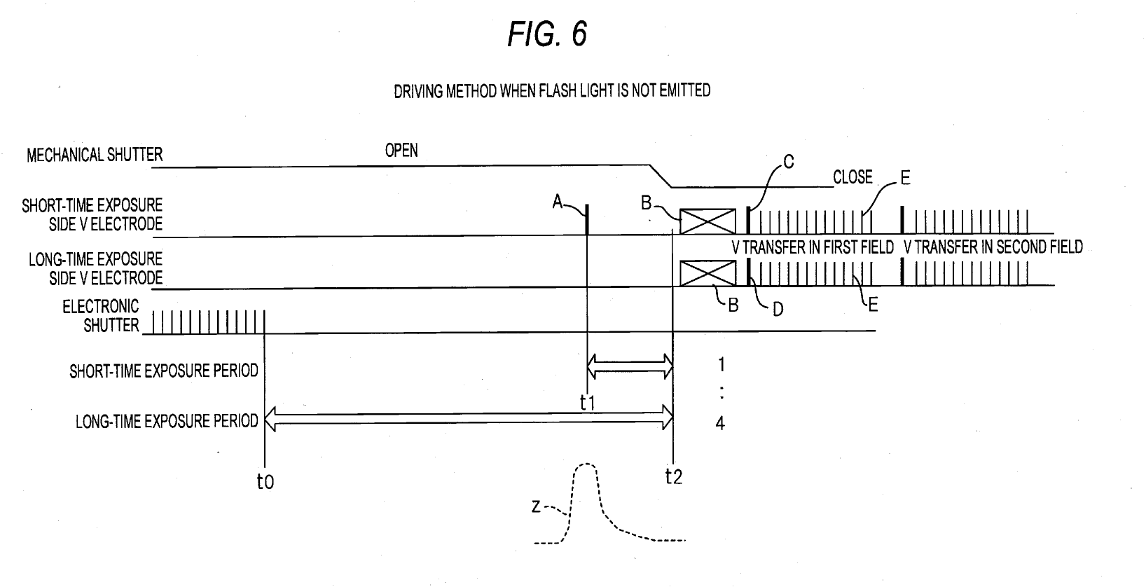

When it is determined in step S4 that the two-stage shutter button is completely pressed and the S2 switch is turned on, the process proceeds to step S6 to perform an imaging operation in a first driving mode which will be described in detail with reference to FIG. 6.

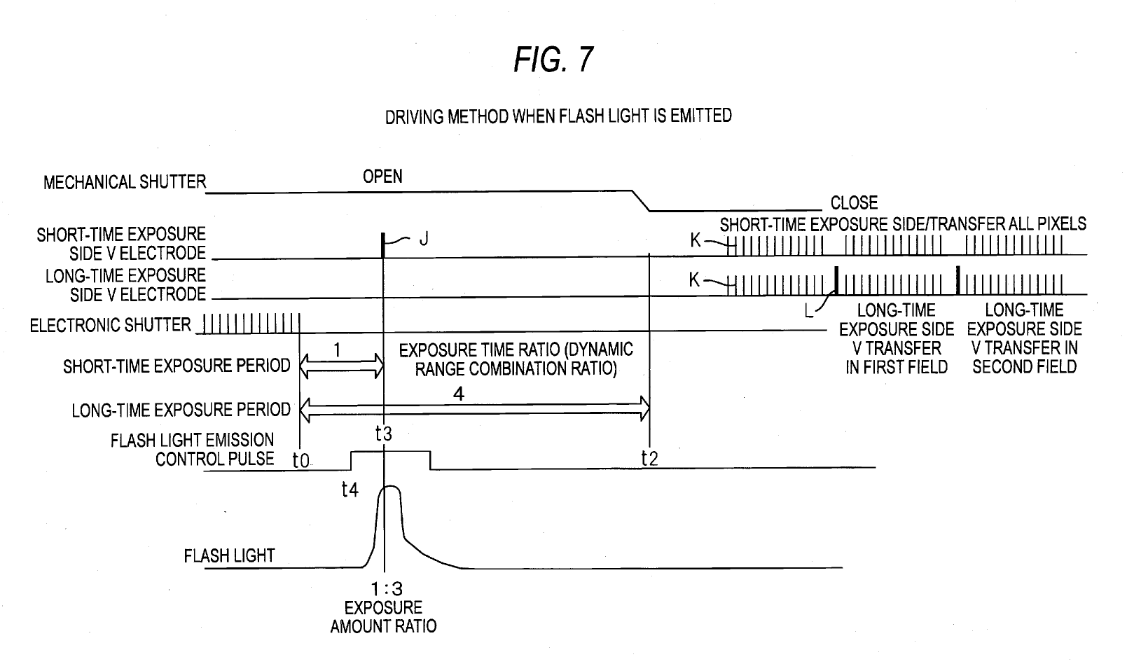

When it is determined in step S5 that the two-stage shutter button is completely pressed and the S2 switch is turned on, the process proceeds to step S7 to perform an imaging operation in a second driving mode which will be described in detail with reference to FIG. 7.

The imaging operation is performed in steps S6 and S7, and a picked-up image signal is output from the solid-state imaging apparatus 11. Then, image processing is performed in step S8 to store the image-processed subject image data in the recording media 31 (step S9), and the process returns to step S1 to perform the next shooting operation.

FIG. 6 is a timing chart explaining the first driving mode which is performed in step S6, when a flash light emission is not performed. Since the mechanical shutter 12 is in an ‘opened’ state, the long-time exposure pixels (first pixel group) and the short-time exposure pixels (second pixel group) are set in a light reception state. However, since an electronic shutter pulse is continuously applied to the semiconductor substrate 60, the signal charges generated by the light reception are immediately discarded toward the semiconductor substrate 60, even though the charges are stored in the respective pixels.

When the application of electronic shutter pulse is stopped at timing t0 in accordance with the timing with which the two-stage shutter button is completely pressed, the storage of signal charges depending on the amount of received light starts in the long-time exposure pixels and the short-time exposure pixels. When the time ratio of the long-time exposure to the short-time exposure is set to 4:1 and timing with which the mechanical shutter 12 is ‘closed’ is set to t2, incident light enters the long-time exposure pixels for a time of ‘t2-t0’ and the signal charges are stored.

When a read pulse A is applied to the read electrodes (V3 and V7 in FIG. 4) for the short-time exposure pixels at timing t1, the signal charges stored in the short-time exposure pixels from timing t0 to timing t1 are read into the vertical charge transfer path. Then, the charge stored in the short-time exposure pixels become ‘zero’. Thereafter, the storage of signal charges is resumed.

When timing t1 at which the read pulse A is applied is set to be before timing t2 by a quarter of the ‘t2-t0’ period, ‘t2-t0’:‘t2-t1’ becomes 4:1.

When the mechanical shutter 12 is ‘closed’ at timing t2, the incident light on the long-time exposure pixels and the short-time exposure pixels is blocked, and the exposure is ended. Accordingly, the signal charges in accordance with the exposure time of ‘t2-t0’ are stored in the long-time exposure pixels, and the signal charges in accordance with the exposure time of ‘t2-t1’ are stored in the short-time exposure pixels.

Since the entire short-time exposure period becomes a portion of the long-time exposure period, the simultaneity between an image obtained by the long-time exposure and an image obtained by the short-time exposure is guaranteed.

When a high-speed flush driving pulse B is applied to the entire vertical charge transfer path 52 after the mechanical shutter 12 is ‘closed’, unnecessary charges on the vertical charge transfer path 52 are flushed and discarded at a high speed. Furthermore, the charges read into the vertical charge transfer path 52 from the short-time exposure pixels by the read pulse A at timing t1 are also discarded, and the vertical charge transfer path 52 are cleared. Then, when a read pulse C is applied to the electrodes V3 and V7 of FIG. 4, the signal charges are read into the vertical charge transfer path from the short-time exposure pixels. When a read pulse D is applied to the electrodes V1 and V5 of FIG. 4, the signal charges are read into the vertical charge transfer path from the long-time exposure pixels. After that, the vertical charge transfer path 52 is driven by a vertical transfer pulse E to transfer the signal charges.

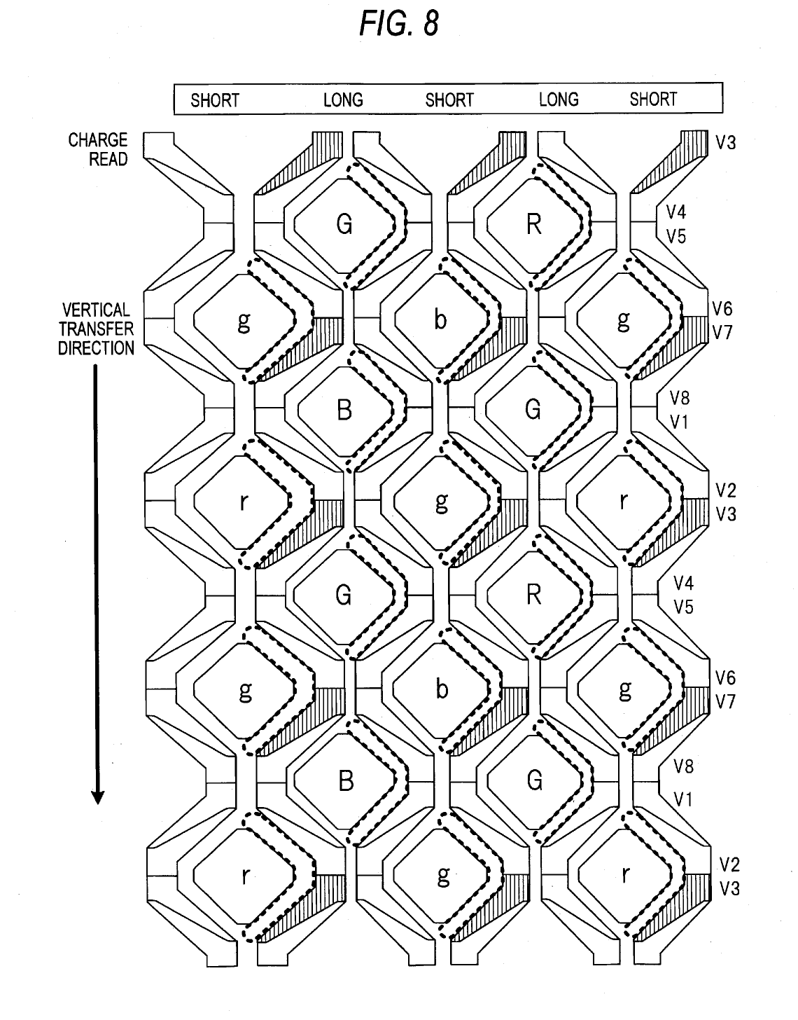

As described with reference to FIG. 2, the multi-field read is generally performed in the recent solid-stat imaging element, in order to read and transfer the signal charges. In this embodiment, the multi-field read is also performed. FIG. 6 shows the two-field read operation. The details of the read operation will be described using FIG. 8 and the following drawings.

FIG. 7 is a timing chart for explaining the second driving mode which is performed in step S7, when the flash light emission is performed. Although in the first driving mode of FIG. 6, the driving method is used where the last section of the long-time exposure period is overlapped with the short-time exposure period, a driving method is used where the first section of the long-time exposure period is overlapped with the short-time exposure period in the second driving mode of step S7 when the flash light emission is performed.

That is, the application of electronic shutter pulse is stopped at timing t0 at which the mechanical shutter 12 is in an ‘opened’ state, and the storage of signal charges in the long-time exposure pixels and the short-time exposure pixels starts. Similar to the first driving mode of FIG. 6, the exposure of the long-time exposure pixels is ended at timing t2 at which the mechanical shutter is ‘closed’. However, a read pulse J is applied to the read electrodes V3 and V7 of the short-time exposure pixels at timing t3 which is a time of (t2-t0)/4 from timing to. Accordingly, the signal charges stored in the short-time exposure pixels are read into the vertical charge transfer path 52 for an exposure time of ‘t3-t0’.

The signal charges are held on the vertical charge transfer path until the long-time exposure period is ended. Although the charge storage is also performed in the short-time exposure pixels from timing t3 to timing t2 at which the mechanical shutter is ‘closed’, the read operation of the stored charges is not performed.

As a transfer pulse K is applied to the vertical charge transfer path 52 after timing t2, the signal charges of the short-time exposure pixels which are read at timing t3 are transferred to the horizontal charge transfer path and transferred along the horizontal charge transfer path. Then, the signal charges are output from the solid-state imaging element 11.

After the signal charges of the short-time exposure pixels are output, a read pulse L is applied to the read electrodes V1 and V5 of the long-time exposure pixels such that the signal charges of the long-time exposure pixels are read into the vertical charge transfer path. In this embodiment, the two-field read is performed.

In the second driving mode, the flush driving which is performed by the high-speed flush pulse B in the first driving mode is not performed. That is because, when the high-speed flush driving is performed, the signal charges read at timing t3 on the vertical charge transfer path may be discarded. When the vertical charge transfer path is not flushed at a high speed, noise charges or the like on the vertical charge transfer path cannot be flushed. However, during the shooting of a dark scene or the shooting into light in which flash is required, noise charges on the vertical charge transfer path are smaller than during the shooting of a scene in which flash is not required. Therefore, although the flush driving is not performed, an image with lots of noise is not generated.

When the short-time exposure period is set to the first section of the long-time exposure period in the second driving mode, it is easy to control a predetermined amount of light to be incident on the short-time exposure pixels. The predetermined amount of light corresponds to a portion (¼ in this example) of the entire amount of light reflected from a subject due to the flash light emission.

The flash light emission is performed by storing power from battery power in a capacitor and applying a control pulse in a burst to channel the charges stored in the capacitor to a flash light emission tube. At this time, the rise of the light emission drops sharply as shown in the lowermost side of FIG. 7, but the end portion of the light emission has a smooth slope. However, the end portion of the light emission may not be constant due to change of the capacitor characteristics over time.

When it is assumed that a flash light emission Z is performed around timing t1 as shown in the lowermost side of FIG. 6, the entire flash light emission Z is performed within the long-time exposure period. The overall amount of light is reflected as signal charges of the long-time exposure pixels.

In the above-described example, in regard to this, the short-time exposure period is set to ¼ of the long-time exposure period. Therefore, control may be performed in such a manner that ¼ of the flash light emission amount enters the short-time exposure pixels. However, it is not easy to perform a control such that ¼ of the flash light emission amount enters the short-time exposure pixels, because of attenuation (the end portion of the flash light emission) of the flash light emission amount which may not be constant due to a secular change and the like.

That is, the timing control of the flash light emission is difficult. For example, it is difficult to determine at which timing the flash light emission is to be performed such that ¼ of the flash light emission amount enters the short-time exposure pixels. Furthermore, when the characteristic of the capacitor for the flash light emission changes over time, the timing of the flash light emission should be changed in accordance with the changes.

Therefore, in the second driving mode of this embodiment, the flash light emission is controlled in such a manner that ¼ of the flash light emission amount enters the short-time exposure pixels in the initial section of the flash light emission. The change in the light amount in the initial section of the flash light emission may be considered to be constant, even though the capacitor characteristic or the like has changed. In the above-described example, it is easy to control the flash light emission in the initial section such that ¼ of the flash light emission amount enters the short-time exposure pixels, and highly precise control can be maintained.

FIG. 8 is a diagram for explaining that the signal charges are read and transferred from the short-time exposure pixels of the second pixel group to the vertical charge transfer path. The short-time exposure pixels are pixels on which the color filters represented by lowercase letters r, g, and b are stacked. In an example shown in FIG. 8, as a read pulse voltage (for example, +13.0 V) is applied to the electrodes V3 and V7, the signal charges of the short-time exposure pixels are read into potential packets formed under the electrodes V3 and V7. The potential packets correspond to vertically shaded portions in FIG. 8.

Since the amount of charge stored in the short-time exposure pixels (the signal charge amount) is small due to the short exposure time, the saturation capacity of the potential packet receiving the signal charge amount may be also small. Therefore, the potential packet for the read operation may be implemented as a small packet. In the example shown in FIG. 8, the capacity of the potential packet is set to the length of one electrode (the electrode V3 or V7) which is the smallest unit.

The potential packets holding signal charges are expanded and contracted in the vertical transfer direction and transferred in the direction of the horizontal charge transfer path. When the potential packet under the electrode V3 is taken as an example, the electrodes V3 and V4 are set to a voltage VM (for example, 0 V), and the electrodes V1, V2, V5, and V6 are set to a voltage VL (for example, −8 V). The potential packet receiving signal charges corresponds to two electrodes. Next, when the electrode V3 is set to the voltage VL, the potential packet receiving signal charges corresponds to one electrode under the electrode V4 and the amount of signal charge corresponding to one electrode is transferred in the vertical direction.

When such a transfer operation is consecutively performed for four electrodes, signal charges corresponding to one pixel line are transferred to the horizontal charge transfer path. Thereafter, the transfer operation of the vertical charge transfer path is stopped. While the transfer operation is stopped, the horizontal charge transfer path is transferred to output a picked-up image signal depending on the amount of signal charge from the amplifier 54, and the above-described operation is repetitively performed.

Since the short-time exposure pixels hold a small amount of signal charge, the signals of all the pixels of the second pixel group can be output by one read operation.

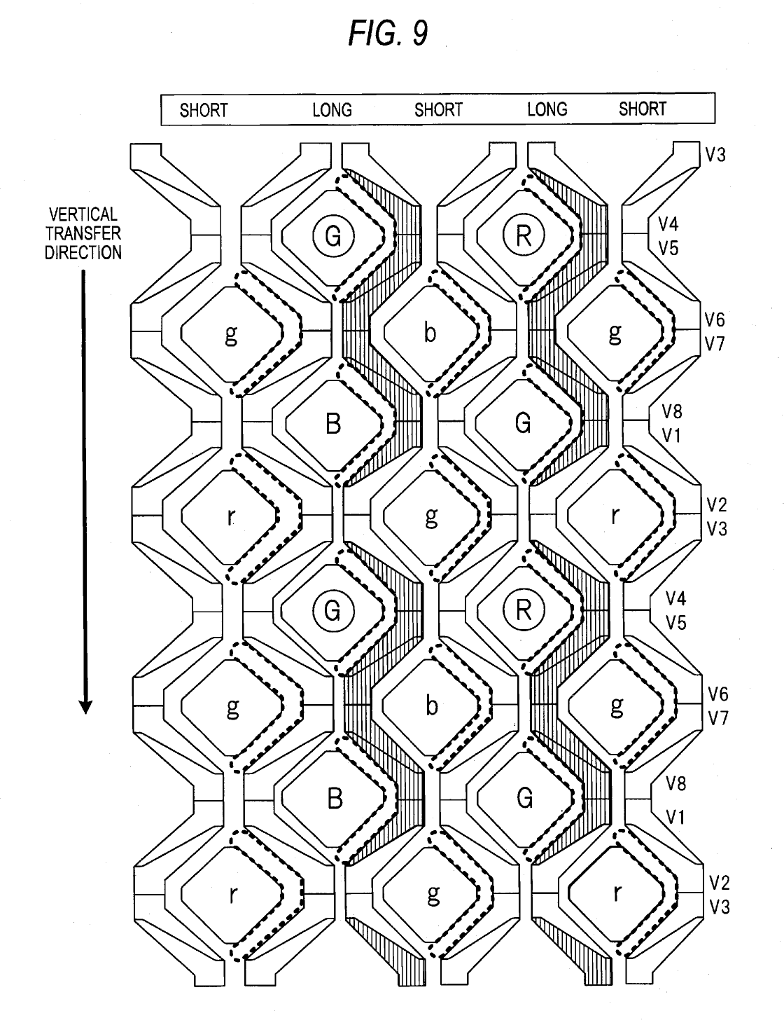

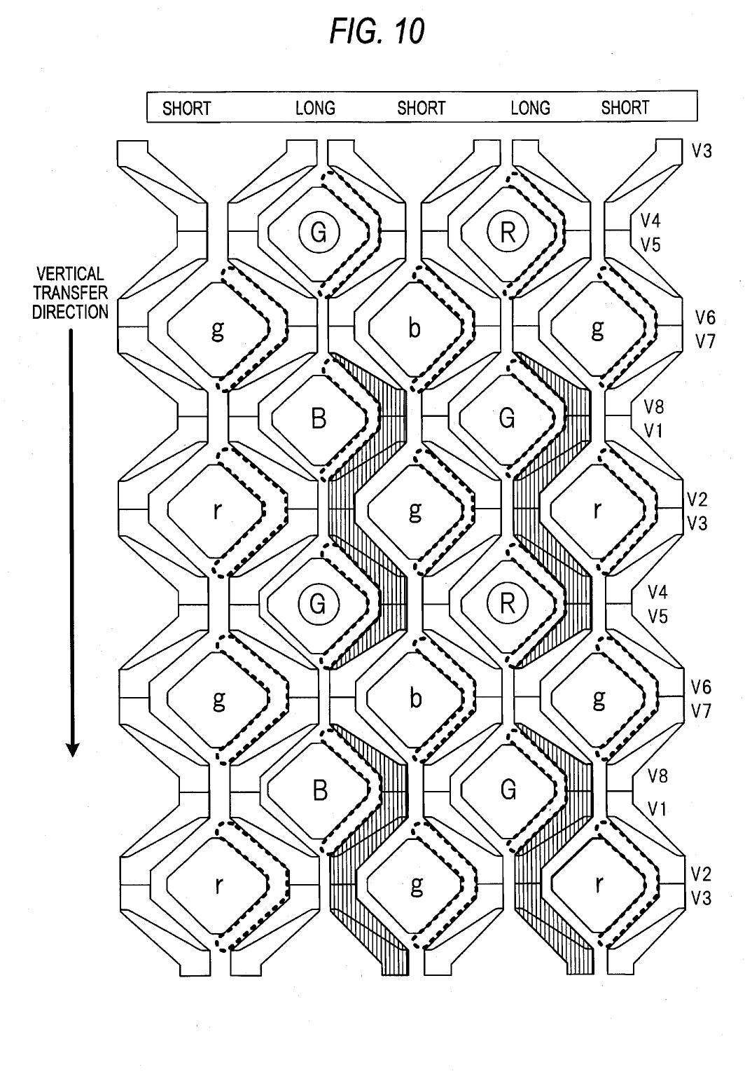

FIGS. 9 and 10 are diagrams for explaining that the signal charges are read and transferred from the long-time exposure pixels of the first pixel group to the vertical charge transfer path. The long-time exposure pixels are pixels on which color filters represented by uppercase letters R, G, and B are stacked. Since the amount of signal charge stored in the long-time exposure pixel is large, the signal charges need to be transferred using a potential packet having a large capacity. In this embodiment, when the signal charges are read and transferred from the long-time exposure pixels, the reading and transfer operation is divided into two operations to be performed.

As shown in FIG. 9, signal charges are read and transferred from alternate pixels (pixels represented by “O” in FIG. 9) among the long-time exposure pixels, which are surrounded by a circle in the drawing, and output from the amplifier 54. Then, as shown in FIG. 10, signal charges are read and transferred from the remaining alternate pixels and output from the amplifier 54.

In FIG. 9, a voltage VM (0 V) is applied to the electrodes V4, V5, V6, V7, V8, and V1 and a voltage VL (−8V) is applied to the electrodes V2 and V3 to form a potential packet having a length corresponding to six electrodes. The potential packet corresponds to a portion shaded with vertical lines. When a high voltage VH (read voltage, for example, +13 V) is applied to the electrode V5, the signal voltages are read from the long-time exposure pixels within the potential packet. After that, potential packets corresponding to six electrodes→five electrodes→six electrodes→ . . . are expanded and contracted to perform the transfer.

In FIG. 10, a potential packet corresponding to six electrodes V8, V1, V2, V3, V4, and V5 is formed, and a read pulse is applied to the electrode V1 to read signal charges, similar to FIG. 9. Then, the transfer is performed in the same manner.

As such, when the reading and transfer of the signal charges from the long-time exposure pixels with a large signal charge amount is performed in multi-fields, toughness due to the incidence of excessive light can be improved, and blooming performance can be improved.

FIGS. 9 and 10 are diagrams for explaining the reading method when a large amount of signal charge is stored in the long-time exposure pixel. However, even the long-time exposure pixels may have a small signal charge amount. For example, when a shooting scene is dark, the scene may be shot by the imaging apparatus 10 in a high-sensitivity mode of which the sensitivity is equal to or more than a predetermined sensitivity (for example, ISO sensitivity 400 and 800). In this high-sensitivity mode, the signal charges are scarcely stored in the short-time exposure pixel. Therefore, a subject image is obtained using only the signal charges stored in the long-time exposure pixel.

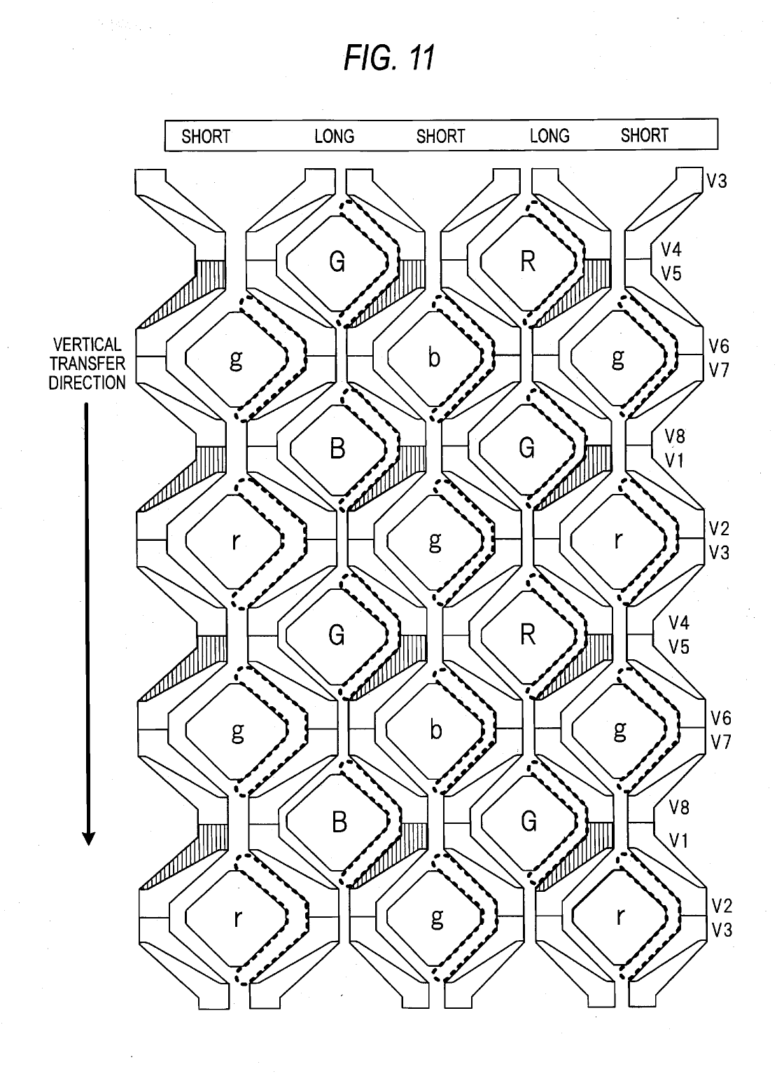

In this case, as shown in FIG. 11, the reading and transfer of the signal charges from the long-time exposure pixel is performed in one field (single field) in a state in which the potential packet is set to only one electrode (the electrode V1 or V5) which is the smallest unit, similar to the signal reading of the short-time exposure pixel of FIG. 8.

Accordingly, a frame rate in the high-sensitivity mode can be increased to improve a continuous shooting function. Furthermore, when the potential packet to be transferred is small, noise can be reduced to improve the quality of a shot image.

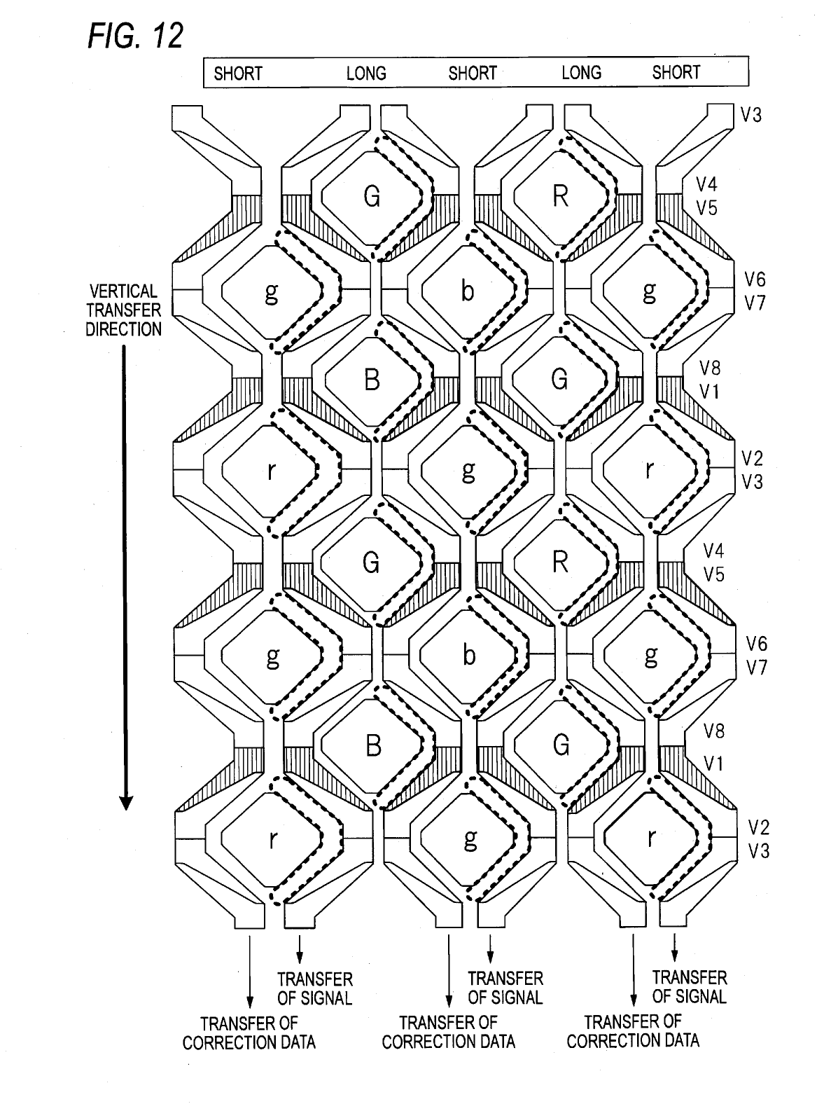

In FIG. 8, it has been described that a read pulse is applied to the electrodes V3 and V7 to read the signal charges from the short-time exposure pixel into the potential packet and the transfer of the potential packet is performed. At this time, however, the same transfer pulse as the transfer electrode of the vertical charge transfer path adjacent to the short-time exposure pixel is applied to the transfer electrode of the vertical charge transfer path adjacent to the long-time exposure pixel, and the transfer of the potential packet is performed as shown in FIG. 12.

In FIG. 8, the description of the vertical charge transfer path adjacent to the long-time exposure pixel has been omitted. However, when the transfer of the detection charges (signal charges) of the short-time exposure pixel is performed in the vertical charge transfer path adjacent to the short-time exposure pixel, an empty potential packet is transferred in the vertical charge transfer path adjacent to the long-time exposure pixel.

When blooming occurs, the charges enter the empty potential packet. Furthermore, smear charges also enter the empty potential packet. Although such noise charges are sent into the empty potential packet, noise data caused by the noise charges are read and stored in the noise correction data storage region 26d of the VRAM 26 of FIG. 1. Furthermore, the noise data may be subtracted from the picked-up image signal read from the short-time exposure pixel, which makes it possible to minimize the quality degradation.

According to the embodiment of the present invention, a subject image with a wide dynamic range can be imaged from the picked-up image signal of the long-time exposure pixels and the short-time exposure pixels where the simultaneity is guaranteed. Furthermore, the flash light emission can be performed at the timing in accordance with the dynamic range ratio, even when a shooting scene is dark or shooting into light. Therefore, it is possible to reduce the halation of the subject regardless of indoor and outdoor environments.

Furthermore, since the configuration for performing the multi-field read is used, an imaging element can be used where the pixel area has been increased, that is, the vertical charge transfer path has been narrowed. Therefore, higher sensitivity can be realized and blooming resistance can be improved.

Furthermore, since smear charges or blooming charges are detected when the signal charges of the short-time exposure pixel are read, it is possible to minimize the degradation of image quality caused by the noise charges.

In the above-described embodiment, the CCD solid-state imaging element has been described. However, the relation between the long-time exposure and the short-time exposure and the flash light emission control may be applied to other types of solid-state imaging elements such as a CMOS solid-state imaging element.

The imaging apparatus (and the method of driving the same) according to the embodiment of the present invention includes: an imaging element in which first and second pixels for storing signal charges in accordance with an amount of received light are alternately arranged in an array; a flash light emission unit that emits flash light in a shooting scene in which the flash light is emitted; and an imaging control unit that exposes the first pixels for a long time, and exposes the second pixels for a short time. An exposure period of the short-time exposure corresponds to a portion of an exposure period of the long-time exposure. The imaging control unit starts the short-time exposure and the long-time exposure at the same time in the shooting scene in which flash light is emitted, ends the short-time exposure earlier than the long-time exposure, and causes the flash light emission unit to start emitting the flash light at required timing immediately before the end timing of the short-time exposure.

In the imaging apparatus (and the method of driving the same) according to the embodiment of the present invention, when the exposure period of the long-time exposure is n times longer than the exposure period of the short-time exposure, timing with which an amount corresponding to 1/n of a total amount of the flash light is emitted during the short-time exposure may set as the required timing.

In the imaging apparatus (and the method of driving the same) according to the embodiment of the present invention, in a shooting scene in which the flash light emission is not performed, the short-time exposure may be started after the long-time exposure is started, and the short-time exposure and the long-time exposure may be stopped at the same time.

In the imaging apparatus (and the method of driving the same) according to the embodiment of the present invention, the long-time exposure may be started by stopping application of an electronic shutter pulse, and the long-time exposure may be ended by closing a mechanical shutter.

In the imaging apparatus (and the method of driving the same) according to the embodiment of the present invention, the first pixels may be arranged in a lattice pattern. Color filters in three primary colors respectively stacked on the first pixels may be arranged to form a Bayer arrangement. The second pixels may be are arranged in a lattice pattern. Color filters in three primary colors respectively stacked on the second pixels may be arranged to form a Bayer arrangement.

In the imaging apparatus (and the method of driving the same) according to the embodiment of the present invention, a pixel line of the first pixels and a pixel line of the second pixels may be alternately arranged and spaced from each other by ½ pixel pitch.

In the imaging apparatus (and the method of driving the same) according to the embodiment of the present invention, detection signals of the first and second pixels adjacent to each other, on which the color filters having the same color are stacked, may be added.

In the imaging apparatus (and the method of driving the same) according to the embodiment of the present invention, the imaging element may be a charge coupled device (CCD) imaging element. The imaging element may include: vertical charge transfer paths through which signal charges read from the first and second pixels are transferred, a horizontal charge transfer path through which the signal charges received from the vertical charge transfer paths are transferred to an output amplifier.

In the imaging apparatus (and the method of driving the same) according to the embodiment of the present invention, the imaging apparatus may include a line memory that is provided between a transfer-direction end of the vertical charge transfer paths and the horizontal charge transfer path. The line memory adds the signal charges of the first and second pixels adjacent to each other, on which the color filters having the same color are stacked, on the horizontal charge transfer path.

In the imaging apparatus (and the method of driving the same) according to the embodiment of the present invention, the signal charges of the first pixels may be read in multi-field.

In the imaging apparatus (and the method of driving the same) according to the embodiment of the present invention, the signal charges of the first pixels may be read in single-field in a high-sensitivity shooting mode of which ISO sensitivity is equal to or more than a predetermined sensitivity.

In the imaging apparatus (and the method of driving the same) according to the embodiment of the present invention, the signal charges the second pixels may be read in single-field.

In the imaging apparatus (and the method of driving the same) according to the embodiment of the present invention, a capacity of a potential packet for receiving the signal charges when the reading and transferring of the signal charges is performed in single-field may be set to be smaller than a capacity of a potential packet when the reading and transfer of the signal charges is performed in multi-field.

In the imaging apparatus (and the method of driving the same) according to the embodiment of the present invention, the capacity of the potential packet receiving the signal charges when the reading and transfer of the signal charges is performed in single-field may be set to a capacity of the smallest unit.

In the imaging apparatus (and the method of driving the same) according to the embodiment of the present invention, when the signal charges of the second pixels are read and transferred to the vertical charge transfer paths, an empty potential packet may be sent to vertical charge transfer paths which are not used for transferring the signal charges in order to detect noise charges, and noise caused by the noise charges may be subtracted from picked-up image data based on detection charges of the second pixels.

In the imaging apparatus (and the method of driving the same) according to the embodiment of the present invention, a transfer driving for reading the signal charges from the first pixels may be different from a transfer driving for reading the signal charges from the second pixels.

According to the embodiment of the present invention, when the short-time exposed image and the long-time exposed image where the simultaneity is guaranteed are combined and a subject image with a wide dynamic range is imaged, the flash light emission can be performed, which makes it possible to process various shooting scenes.

### INDUSTRIAL APPLICABILITY

In the imaging apparatus according to the embodiment of the present invention, only the flash light emission amount in accordance with the time ratio of the short-time exposure period to the long-time exposure period is easily allocated to the short-time exposure pixels when the flash light is emitted. Therefore, when a subject image with a wide dynamic range is imaged, the flash light emission can be performed. Accordingly, the imaging apparatus may be usefully applied to a digital camera, a camera mounted in a mobile phone or the like.

What is claimed is:

1. An imaging apparatus comprising:
an imaging element in which first and second pixels for storing signal charges in accordance with an amount of received light are alternately arranged in an array;
a flash light emission unit that emits flash light in a shooting scene in which the flash light is emitted; and
an imaging control unit that exposes the first pixels for a long time, and exposes the second pixels for a short time,
wherein an exposure period of the short-time exposure corresponds to a portion of an exposure period of the long-time exposure, and
wherein the imaging control unit starts the short-time exposure and the long-time exposure at the same time in the shooting scene in which flash light is emitted, ends the short-time exposure earlier than the long-time exposure, and causes the flash light emission unit to start emitting the flash light at required timing immediately before the end timing of the short-time exposure.

2. The imaging apparatus according to claim 1,
wherein when the exposure period of the long-time exposure is n times longer than the exposure period of the short-time exposure, timing with which an amount corresponding to 1/n of a total amount of the flash light is emitted during the short-time exposure is set as the required timing.

3. The imaging apparatus according to claim 1,
wherein in a shooting scene in which the flash light emission is not performed, the short-time exposure is started after the long-time exposure is started, and the short-time exposure and the long-time exposure are stopped at the same time.

4. The imaging apparatus according to claim 1,
wherein the long-time exposure is started by stopping application of an electronic shutter pulse, and the long-time exposure is ended by closing a mechanical shutter.

5. The imaging apparatus according to claim 1,
wherein the first pixels are arranged in a lattice pattern,
color filters in three primary colors respectively stacked on the first pixels are arranged to form a Bayer arrangement,
the second pixels are arranged in a lattice pattern, and
color filters in three primary colors respectively stacked on the second pixels are arranged to form a Bayer arrangement.

6. The imaging apparatus according to claim 5,
wherein a pixel line of the first pixels and a pixel line of the second pixels are alternately arranged and spaced from each other by ½ pixel pitch.

7. The imaging apparatus according to claim 5,
wherein detection signals of the first and second pixels adjacent to each other, on which the color filters having the same color are stacked, are added.

8. The imaging apparatus according to claim 1,
wherein the imaging element is a charge coupled device (CCD) imaging element,
the imaging element includes:
vertical charge transfer paths through which signal charges read from the first and second pixels are transferred; and
a horizontal charge transfer path through which the signal charges received from the vertical charge transfer paths are transferred to an output amplifier.

9. The imaging apparatus according to claim 8, further comprising:
a line memory that is provided between a transfer-direction end of the vertical charge transfer paths and the horizontal charge transfer path,
wherein the line memory adds the signal charges of the first and second pixels adjacent to each other, on which the color filters having the same color are stacked, on the horizontal charge transfer path.

10. The imaging apparatus according to claim 8,
wherein the signal charges of the first pixels are read in multi-field.

11. The imaging apparatus according to claim 8,
wherein the signal charges of the first pixels are read in single-field in a high-sensitivity shooting mode of which ISO sensitivity is equal to or more than a predetermined sensitivity.

12. The imaging apparatus according to claim 8,
wherein the signal charges the second pixels are read in single-field.

13. The imaging apparatus according to claim 11,
wherein a capacity of a potential packet for receiving the signal charges when the reading and transferring of the signal charges is performed in single-field is set to be smaller than a capacity of a potential packet when the reading and transfer of the signal charges is performed in multi-field.

14. The imaging apparatus according to claim 13,
wherein the capacity of the potential packet receiving the signal charges when the reading and transfer of the signal charges is performed in single-field is set to a capacity of the smallest unit.

15. The imaging apparatus according to claim 8,
wherein when the signal charges of the second pixels are read and transferred to the vertical charge transfer paths, an empty potential packet is sent to vertical charge transfer paths which are not used for transferring the signal charges in order to detect noise charges, and noise caused by the noise charges is subtracted from picked-up image data based on detection charges of the second pixels.

16. The imaging apparatus according to claim 8,
wherein a transfer driving for reading the signal charges from the first pixels is different from a transfer driving for reading the signal charges from the second pixels.

17. A method of driving an imaging apparatus which images a subject image by emitting flash light in a shooting scene in which flash light is emitted and using an imaging element in which first and second pixels for storing signal charges in accordance with an amount of received light are alternately arranged in an array, the method comprising:
exposing the first pixels for a long time;
exposing the second pixels for a short time, a exposure period of the short-time exposure corresponding to a portion of a exposure period of the long-time exposure;
starting the short-time exposure and the long-time exposure at the same time in the shooting scene in which the flash light is emitted;
ending the short-time exposure earlier than the long-time exposure; and
starting the flash light emission at required timing immediately before the end timing of the short-time exposure.

18. The method according to claim 17,
wherein when the exposure period of the long-time exposure is n times longer than the exposure period of the short-time exposure, timing with which an amount corresponding to 1/n of a total amount of the flash light is emitted during the short-time exposure is set as the required timing.

19. The method according to claim 17,
wherein in a shooting scene in which the flash light emission is not performed, the short-time exposure is started after the long-time exposure is started, and the short-time exposure and the long-time exposure are stopped at the same time.

20. The method according to claim 17,
wherein the long-time exposure is started by stopping application of an electronic shutter pulse, and the long-time exposure is ended by closing a mechanical shutter.

21. The method according to claim 17,
wherein the first pixels are arranged in a lattice pattern,
color filters in three primary colors respectively stacked on the first pixels are arranged to form a Bayer arrangement,
the second pixels are arranged in a lattice pattern, and
color filters in three primary colors respectively stacked on the second pixels are arranged to form a Bayer arrangement.

22. The method according to claim 21,
wherein a pixel line of the first pixels and a pixel line of the second pixels are alternately arranged and spaced from each other by ½ pixel pitch.

23. The method according to claim 21,
wherein detection signals of the first and second pixels adjacent to each other, on which the color filters having the same color are stacked, are added.

24. The method according to claim 17,
wherein the imaging element is a charge coupled device (CCD) imaging element,
the imaging element includes:
vertical charge transfer paths through which signal charges read from the first and second pixels are transferred; and
a horizontal charge transfer path through which the signal charges received from the vertical charge transfer paths are transferred to an output amplifier.

25. The method according to claim 24,
wherein the imaging apparatus includes a line memory that is provided between a transfer-direction end of the vertical charge transfer paths and the horizontal charge transfer path, and
wherein the line memory adds the signal charges of the first and second pixels adjacent to each other, on which the color filters having the same color are stacked, on the horizontal charge transfer path.

26. The method according to claim 24,
wherein the signal charges of the first pixels are read in multi-field.

27. The method according to claim 24,
wherein the signal charges of the first pixels are read in single-field in a high-sensitivity shooting mode of which ISO sensitivity is equal to or more than a predetermined sensitivity.

28. The method according to claim 24,
wherein the signal charges the second pixels are read in single-field.

29. The method according to claim 27,
wherein a capacity of a potential packet for receiving the signal charges when the reading and transferring of the signal charges is performed in single-field is set to be smaller than a capacity of a potential packet when the reading and transfer of the signal charges is performed in multi-field.

30. The method according to claim 29,
wherein the capacity of the potential packet receiving the signal charges when the reading and transfer of the signal charges is performed in single-field is set to a capacity of the smallest unit.

31. The method according to claim 24,
wherein when the signal charges of the second pixels are read and transferred to the vertical charge transfer paths, an empty potential packet is sent to vertical charge transfer paths which are not used for transferring the signal charges in order to detect noise charges, and noise caused by the noise charges is subtracted from picked-up image data based on detection charges of the second pixels.

32. The method according to claim 24,
wherein a transfer driving for reading the signal charges from the first pixels is different from a transfer driving for reading the signal charges from the second pixels.
